(19) United States
(12) Patent Application Publication
(10) Pub. No.: US 2009/0081013 A1
(43) Pub. Date: Mar. 26, 2009

(54) Machine for food waste densification and removal and process for same

(76) Inventors: David Lowe, San Diego, CA (US); Harry Vernon McGahey, JR., San Diego, CA (US)

Correspondence Address: HARRY V. MCGAHEY JR., 1532 SIXTH AVENUE, SAN DIEGO, CA, 92101, US

(21) Appl. No.: 12/220,562

(22) Filed: Jul. 25, 2008

Related U.S. Application Data
(60) Provisional application No. 60/961,855, filed on Jul. 25, 2007.

(51) Int. Cl. B65F 3/04; B65F 3/14

(52) U.S. Cl. 414/408; 414/525.2; 414/806

(57) ABSTRACT

A machine and process for commercial and industrial food waste densification and removal combining a leak proof trailer, a densification system, a trash container, and a dumping mechanism, into a unified collection apparatus. An organic waste generator such as a restaurant can easily store large amounts of its organic liquid and semi-liquid refuse and wastes onsite until the unit is full, then a trash hauler can transport this waste in the leak proof trailer to a municipal landfill or other processing location.

### CROSS REFERENCE TO RELATED APPLICATIONS

This application is based on provisional application Ser. No. 60/961,855, filed on Jul. 25, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of commercial and industrial on-site liquid and semi-liquid waste storage and removal and more specifically to a machine for food waste densification and removal and process for same.

Current trash collection systems in the United States generally leak which makes them inappropriate for collecting large amounts of organic waste streams. In addition, transfer from locally used leak proof containers to trucks to transport the waste entails large amounts of labor and generally results in the waste stream being transported in a leaky trailer or truck bed to its final removal location. Often restaurant personnel are not strong enough to empty the smaller trash receptacles as the fill up by themselves, and have to obtain help to dump them. This tends to cause delays in dumping individual containers with a concomitant amount of over filled and stale containers tending to build up in the rear of restaurants and other organic waste generator's premises.

The current invention combines a leak proof trailer, a densification system, a trash container, and a dumping mechanism, into a unified collection apparatus. An organic waste generator such as a restaurant can easily store large amounts of its organic liquid and semi-liquid refuse and wastes onsite until the unit is full, then a trash hauler can transport this waste in the leak proof trailer to a municipal landfill or other processing location.

### BRIEF SUMMARY OF THE INVENTION

The object of this invention is to provide an improved machine and process to densify and compact food waste from high volume organic waste producers such as restaurants, and compact these wastes for easy removal from the premises where they are generated.

Other objects and advantages of the present invention will become apparent from the following descriptions, taken in connection with the accompanying drawings, wherein, by way of illustration and example, an embodiment of the present invention is disclosed.

This is an invention comprising both a new form of an apparatus for Food Waste Densification and Removal, and a method for Food Waste Densification and Removal using said apparatus. Both the apparatus and the method are designed to densify and compact food waste from high volume organic waste producers such as restaurants, and compact these wastes for easy removal from the premises where they are generated.

In accordance with a preferred embodiment of the invention, there is disclosed a machine for food waste densification and removal comprising: a tote to receive liquid and semi-liquid organic waste, a scale to weigh the tote, a two sided hopper, a tractor means to lift the tote and pour it into the two sided hopper, a control panel means, a lid, a lid enclosure operating means, a liquid tight food waste compactor means comprised of a food waste densification and liquid reduction tube assembly, a trailer modified to be liquid tight by a liquid tight means, the trailer attached to the output end of the liquid tight food waste compactor means, a cleaning means to clean the food waste densification and liquid reduction tube assembly, a cleaning means to clean the trailer, and a sealable door means for the trailer.

Also in accordance with a preferred embodiment of the invention, there is disclosed a process for food waste densification and removal comprising the steps of: filing a tote with liquid and semi-liquid organic waste, using a scale to weigh the tote, using a tractor means to lift the tote and pour it into a two sided hopper, sealing the hopper with a lid operated by a lid enclosure operating means, compacting the liquid and semi-liquid waste with a liquid tight food waste compactor means comprised of a a food waste densification and liquid reduction tube assembly, pushing the compacted waste into a trailer modified to be liquid tight by a liquid tight means, utilizing a cleaning means to clean the food waste densification and liquid reduction tube assembly, disengaging the trailer from the liquid tight food waste compactor means, transporting the trailer to a disposal site, using a cleaning means to clean the trailer

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a side view of the entire densification and removal apparatus/system.

FIG. 2 shows an end view of one side of the apparatus/system.

FIG. 3 shows a side view of the apparatus/system prior to beginning a disposal cycle.

FIG. 4 shows a side view of the apparatus/system during the second phase of a disposal cycle.

FIG. 5 shows an end view of one side of the apparatus/system prior to the beginning of a disposal cycle.

FIG. 6 shows an end view of the apparatus/system during the second phase of a disposal cycle.

FIG. 7 shows an end view of the apparatus/system during the second phase of a disposal cycle.

FIG. 8 shows a top view of the compactor for the densification apparatus/system.

FIG. 9 shows an exterior view of the compactor access door assembly on the trailer comprising the apparatus/system.

FIG. 10A shows a side view of the Dumper Rail Lift Assembly for the apparatus/system.

FIG. 10B shows a front view of the Dumper Rail Lift Assembly for the apparatus/system.

FIG. 11 shows an interior view of compactor access door assembly on the trailer with an inside rear view of a rubber gasket.

FIG. 12 shows an interior view of the compactor access door assembly on the trailer from above.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

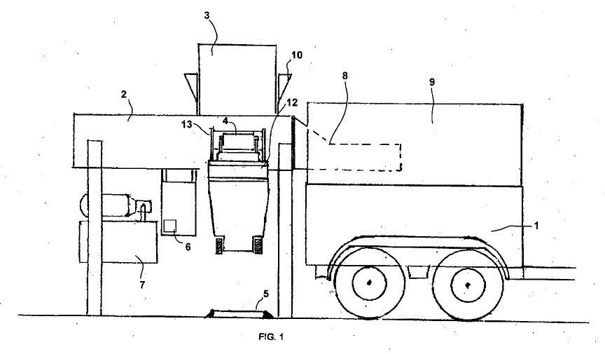

Turning first to FIG. 1 there is shown a side view of the entire densification and removal system. A trailer modified to be liquid tight by a liquid tight means (1) sits on wheels sufficient to hold the amount of waste which will be present when the trailer is fully loaded. In the preferred embodiment, the waterproofing is accomplished by welding pieces of L Bar iron cut to size at the back of the trailer where a typical loading gate means is located. The L Bar iron pieces are anchored around the perimeter of the rear of the trailer near the gate means and covered with an Interior Rubber Gasket or other inert sealing pad material. The pieces of L Bar iron are anchored with a water tight weld or bond and placed such that when the rear door means of the trailer are closed, the pressure of the doors themselves presses on the Inner Rubber Gasket of the L Bar pieces so as to make a water tight trailer. Additional pieces of an Outer Rubber Gasket or other inert sealing pad material are also placed on the rear gate means of the trailer to ensure that the doors themselves do not leak at the hinges or where they meet the L-Bars anchored to the trailer itself. A tight trailer enclosure which is air tight and impervious to vermin such as rodents, insects and other pests (9) is anchored to the trailer (1) by any suitable anchor means.

The Densification System itself is composed of an electronic scale (5) for weighing and keeping track of the amount of food or other organic waste being placed into the system, a Watertight Trash Tote which is typically of a 35, 65 or 95 gallon capacity (12), a Dumper Rail Lift Assembly (13), a Tote Dumper Means (4) such as a Perkins model D6071 tote dumper, a hydraulically operated Compaction Lid (3) (Shown in the open position), a liquid tight food waste compactor means (2), a hydraulic power unit means to operate the compactor (7), and an electronic key card reader and electrical control panel (6). The key reader and control panel contain a modem and weight displays connected to a computer means to allow access only to authorized key card holders and to keep track of the amount of waste which has been dumped to date from the input from the electronic scale (5). This allows the waste company operator supplying the apparatus/system to gauge how much waste has been loaded to date in the current cycle, when the trailer should be picked up for emptying, and an empty trailer put in place of the now full one. A two sided hopper (10) ensures that food waste does not spill as the tote is dumped into the compactor (2) through the open door covered by the Compaction Lid Enclosure 3). After each dumping of a trash tote (12), the compactor (2) then cycles through a compacting cycle, pushing the dumped waste into the Food Waste Densification and Liquid Reduction Tube Assembly (8). The hydraulically operated Compaction Lid (3) opens as the tote is lifted up to dump. It closes automatically after the tote has emptied and the tote is then recycled back to rest on the scale (5).

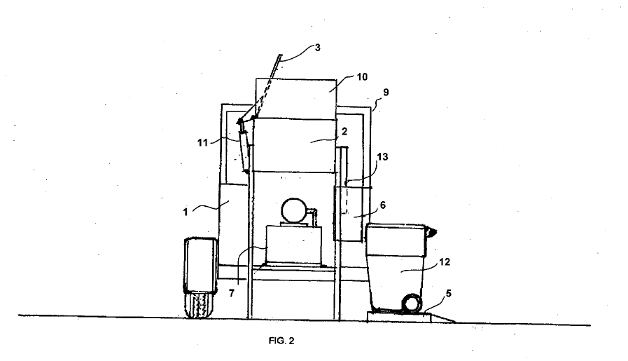

FIG. 2 shows an end view of one side of the apparatus/system. The liquid tight trailer (1) covered by the enclosure which is air tight and impervious to rodents, insects and other pests (9) is shown with the Food Waste Densification system installed onto the water tight trailer. The electronic scale (5) with the watertight trash tote (12), a Dumper Rail Lift Assembly (13), the liquid tight food waste compactor means (2), the hydraulic power unit means (7), and the electronic key card reader and electrical control panel (6) can also be seen. The hopper (10) which ensures that food waste does not spill as the tote is dumped into the compactor (2) surrounds the Lid Enclosure Operating Means (11) which opens and closes the compaction lid. In the preferred embodiment this Lid Enclosure Operating Means is hydraulically operated but any opening means could be used.

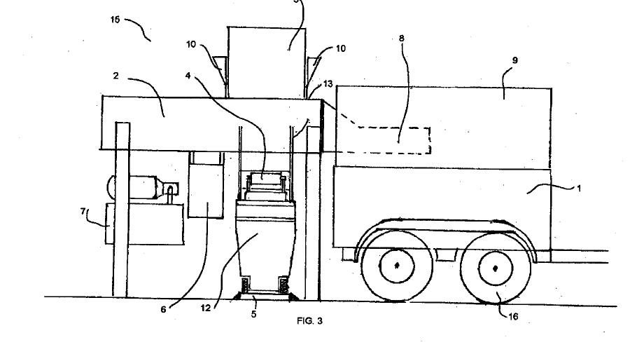

FIG. 3 shows a side view of the entire Food Waste Densification and Removal Apparatus/System (15) prior to beginning a disposal cycle.

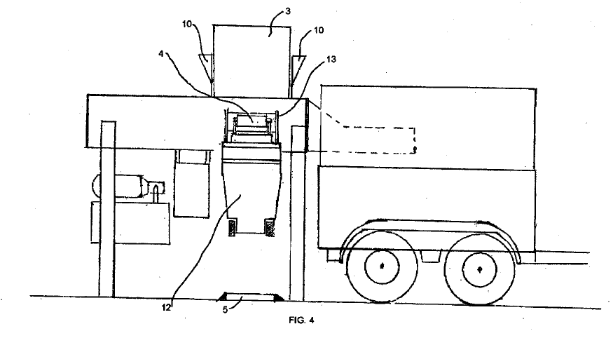

FIG. 4 shows a side view of the apparatus/system during the second phase of a disposal cycle. After being weighed by the electronic scale (5) the tote (12) is lifted up by the Dumper Rail Lift Assembly (13). At the same time the hydraulically operated compactor and enclosure lid (3) opens up to receive the contents of the tote.

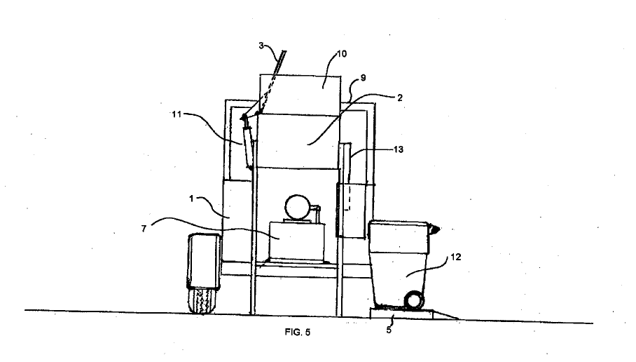

FIG. 5 shows an end view of one side of the apparatus/system prior to the beginning of a disposal cycle.

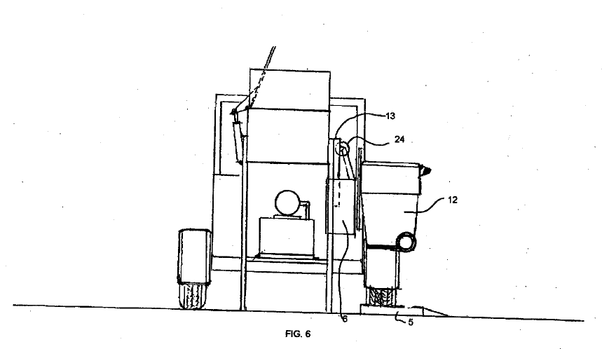

FIG. 6 shows an end view of the system during the second phase of a disposal cycle. The tractor means (24) which lifts the tote (12) along the Dumper Rail Lift Assembly (13) can be seen above and behind the Electronic Key Card Reader (6).

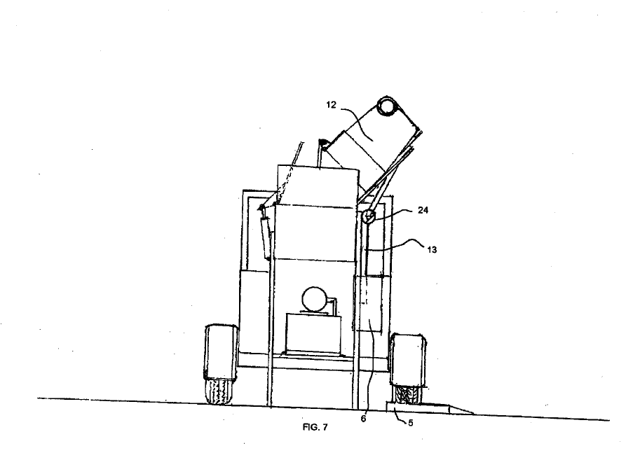

FIG. 7 shows an end view of the system during the third phase of a disposal cycle. The tote (12) has now been lifted by the tractor means (24) along the Dumper Rail Lift Assembly (13) and once it reaches the top, the Tote Dumber means (4) tilts the tote and empties the contents into the compactor.

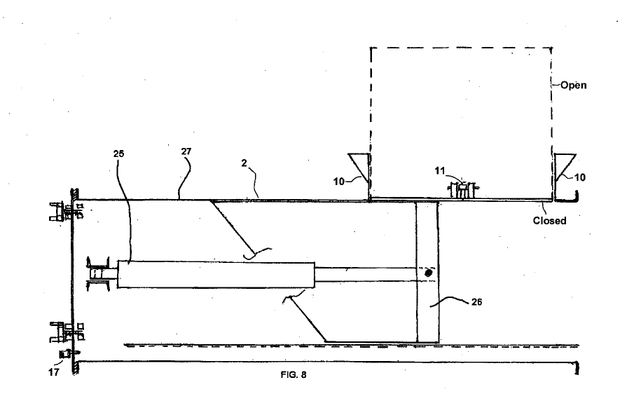

FIG. 8 shows a top view of the compactor for the densification system. In the preferred embodiment, the Liquid Tight Food Waste Compactor (2) is comprised of a hydraulically operated piston (25) operating a Ram (26) inside the Outer Cylinder (27), but any liquid tight compactor means may be used. The Lid Enclosure Operating Means (11) in a closed and open position relative to the two sided hopper (10) is also shown in FIG. 8 (Open is shown with dashed lines). FIG. 8 also shows a plurality of Pressure Washers (17) which are used to help wash the trailer at the end of a cycle when it is being emptied at a landfill or other processing facility.

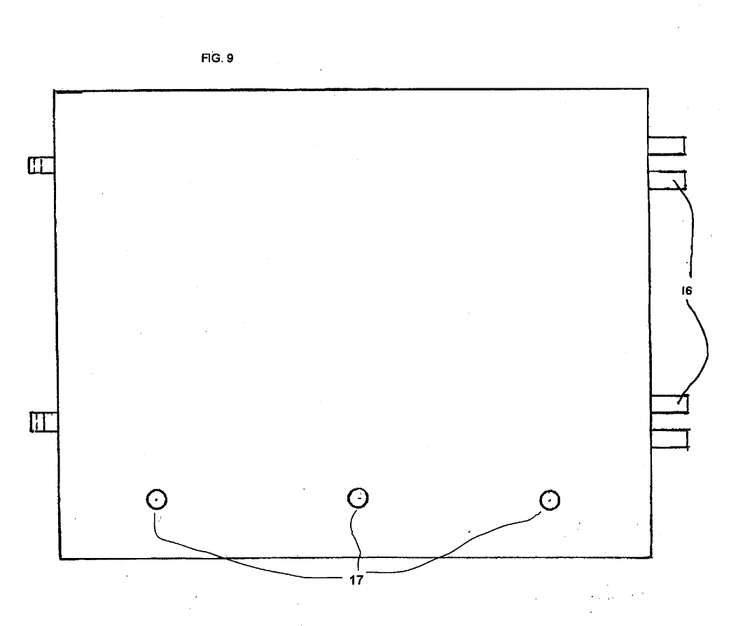

FIG. 9 shows the Access Door Hinges (19) and the plurality of additional Pressure Washers (17) also installed on the bottom of the Lower Trailer Door to assist in emptying and cleaning the trailer.

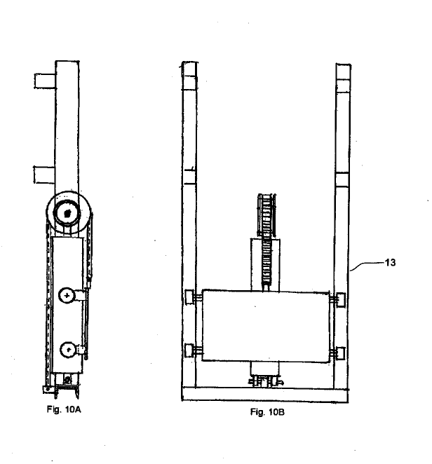

FIG. 10A shows a detailed side view of the preferred tractor means for the Dumper Rail Lift Assembly which in the preferred embodiment is a chain operated pulley system. However any tractor or lifting means able to grab and tip a garbage or trash tote at the top into the open compaction lid opening can be used.

FIG. 10B shows a detailed front view of the same preferred embodiment of the Dumper Rail Lift Assembly using the chain operated system.

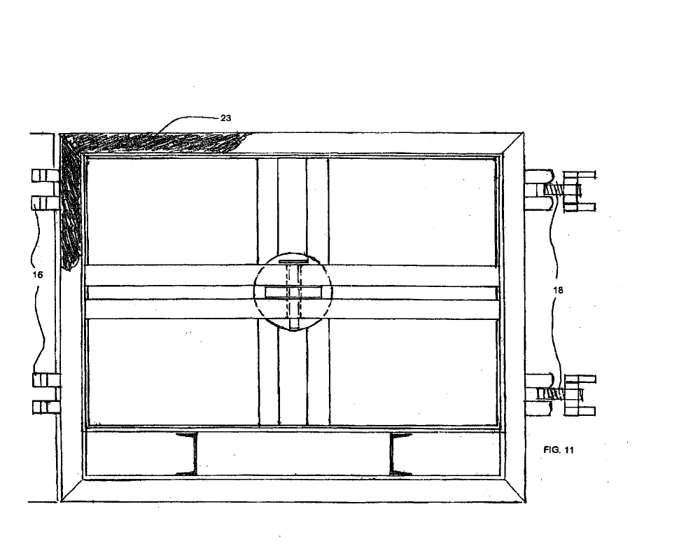

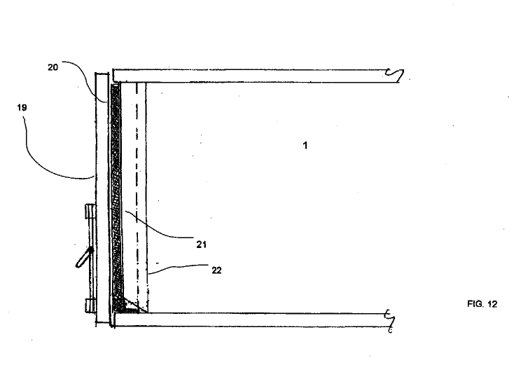

FIG. 11 shows the preferred embodiment for sealing and making the trailer liquid tight. In the preferred embodiment, pieces of L Bar iron are cut to size at the back of the trailer where a typical loading gate means is located. The L Bar iron pieces are anchored around the perimeter of the rear of the trailer near the gate means and covered with an Outer Rubber Gasket or other inert sealing pad material (23). The pieces of L Bar iron are anchored with a water tight weld or bond and placed such that when the rear door means of the trailer are closed, the pressure of the doors themselves presses on the Inner Rubber Gaskets (20) on the L Bar pieces in FIG. 12 so as to make a water tight trailer. The additional pieces of thin rubber or other inert sealing pad material are placed on the rear gate means as an Outer Rubber Gasket (23) of the trailer to ensure that the doors themselves do not leak at the hinges or where they meet the L-Bars anchored to the trailer itself. Latching Dogs (18) are used in the preferred embodiment to attach the rear lower door to the trailer. The tight trailer enclosure which is air tight and impervious to rodents, insects and other pests (9) is anchored to the trailer (1) by any suitable anchor means. A movability means such as tires (16) sufficient to carry the weight of the trailer when loaded are used to transport the trailer to its final destination at a land fill or other location.

FIG. 12 shows the trailer sealing system from above. The Door (19) when compressed presses the Outer Rubber Gasket (23) against the Inner Rubber Gasket (20) anchored to the Seam Welded Angle Iron Flanges (21). The Flat Bar Trash Deflector (22) can also be seen in FIG. 12, as can the Sealable Door Means (28) which is opened to hold the Food Waste Densification and Liquid Reduction Tube Assembly (8) Food Waste Densification and Liquid Reduction Tube Assembly (8) which is inserted into it during the trash tote dumping cycles.

The Food Waste Densification and Removal System is a multiphase apparatus and system which begins when food or other organic waste containing liquids is set in a tote upon the electronic scale (5). FIG. 1 shows a side view of the entire densification and removal system. A trailer modified to be liquid tight by a liquid tight means (1) sits on wheels sufficient to hold the amount of waste which will be present when the trailer is fully loaded. FIG. 11 shows the preferred embodiment for sealing and making the trailer liquid tight. In the preferred embodiment, pieces of L Bar iron are cut to size at the back of the trailer where a typical loading gate means is located. The L Bar iron pieces are anchored around the perimeter of the rear of the trailer near the gate means and covered with a thin Rubber Gasket or other inert sealing pad material (20). The pieces of L Bar iron are anchored with a water tight weld or bond and placed such that when the rear door means of the trailer are closed, the pressure of the doors themselves presses on the Inner Rubber Gaskets (20) on the L Bar pieces so as to make a water tight trailer. Additional pieces of thin rubber or other inert sealing pad material are placed on the rear gate means as an Outer Rubber Gasket (23) of the trailer to ensure that the doors themselves do not leak at the hinges or where they meet the L-Bars anchored to the trailer itself. Latching Dogs (18) are used in the preferred embodiment to attach the rear lower door to the trailer. The tight trailer enclosure which is air tight and impervious to rodents, insects and other pests (9) is anchored to the trailer (1) by any suitable anchor means. Tires (16) sufficient to carry the weight of the trailer when loaded are used to transport the trailer to its final destination at a land fill or other location. FIG. 12 shows the trailer sealing system from above. The Door (19) when compressed presses the Outer Rubber Gasket (23) against the Inner Rubber Gasket (20) anchored to the Seam Welded Angle Iron Flanges (21). The Flat Bar Trash Deflector (22) can also be seen in FIG. 12.

The Densification Apparatus and System itself [(15) in FIG. 3] is composed of an electronic scale (5) for weighing and keeping track of the amount of food or other organic waste being placed into the system, a watertight trash tote which is typically of a 35, 65 or 95 gallon capacity (12), a Dumper Rail Lift Assembly (13), a Tote Dumper Means (4) such as a Perkins model D6071 tote dumper, a hydraulically operated compaction lid enclosure (3), a liquid tight food waste compactor means (2), a hydraulic power unit means (7), and an electronic key card reader and electrical control panel (6).

The key reader and control panel can contain a modem and weight displays connected to a computer means to allow access only to authorized key card holders and to keep track of the amount of waste which has been dumped to date from the input from the electronic scale (5). This allows the waste company operator supplying the system to gauge how much waste has been loaded to date in the current cycle, when the trailer should be picked up for emptying and an empty trailer put in place of the now full one.

A two sided hopper (10) ensures that food waste does not spill as the tote is dumped into the compactor (2). After each dumping cycle of a trash tote (12), the compactor (2) then cycles through a compacting cycle, pushing the dumped waste into a Food Waste Densification and Liquid Reduction Tube Assembly (8). A hydraulically operated compactor lid (3) opens as the tote is lifted up to dump. It closes automatically after the tote has emptied and been recycled back to rest on the scale (5).

In the first phase of the cycle, the waste to be disposed of is placed on the electronic scale (5). FIG. 3 shows a side view of the Food Waste Densification and Removal System (15) prior to beginning a disposal cycle. FIG. 5 shows an end view of one side of the system prior to the beginning of a disposal cycle.

FIG. 4 shows a side view of the system during the second phase of a disposal cycle. After being weighed by the electronic scale (5) the tote (12) is lifted up by the Dumper Rail Lift Assembly (13). At the same time the hydraulically operated compactor and enclosure lid (3) opens up to receive the contents of the tote.

FIG. 6 shows an end view of the system during the second phase of a disposal cycle. The tractor means (24) which lift the tote (12) along the Dumper Rail Lift Assembly (13) can be seen above and behind the Electronic Key Card Reader (6). FIG. 10A shows a detailed side view of the tractor means for the Dumper Rail Lift Assembly which in the preferred embodiment is a chain operated pulley system. FIG. 10B shows a detailed front view of the same preferred embodiment of the Dumper Rail Lift Assembly using the chain operated system. However any lifting means capable of lifting the weight of the tote and tipping it at the top into the open compaction lid opening can be used.

FIG. 7 shows an end view of the system during the third phase of a disposal cycle. The tote (12) has now been lifted by the tractor means (24) along the Dumper Rail Lift Assembly (13) and once it reaches the top, the Tote Dumper means (4) tilts the tote and empties the contents into the compactor. The two sided hopper (10) which ensures that food waste does not spill as the tote is dumped into the compactor (2) surrounds the hydraulically operated lid enclosure means (11) which opens and closes the compaction lid.

In the fourth phase of the cycle, the Liquid Tight Food Waste Compactor means (2) forces the waste just dumped into the Food Waste Densification and Liquid Reduction Tube Assembly (8) where liquid is squeezed out and the solid waste is compacted further before falling into the water tight trailer (1). FIG. 8 shows a side view of the compactor for the densification system. In the preferred embodiment, the Liquid Tight Food Waste Compactor (2) is comprised of a hydraulically operated piston (25) operating a Ram (26) inside the Outer Cylinder (27), but any liquid tight compactor means may be used. The lid enclosure means (11) in a closed and open position relative to the two sided hopper (10) is also shown in FIG. 8.

In the fifth phase of the cycle, the data accumulated in the Electronic Key Card Reader and Control Panel (6) is sent out by a modem or cellular phone system means to the owner of the System (15) so they know when to swap out a full trailer with an empty one.

In the sixth phase of the cycle, the full water tight trailer (1) with the Liquid Tight Trailer Enclosure (9) is exchanged for an empty one and the full trailer is then transported by a tractor or truck means to a landfill or other disposal processing facility. In the Sixth and final phase, the Liquid Tight Trailer Enclosure (9) is emptied, cleaned using the installed Pressure Washers (17) and/or by other cleaning means, and recycled by taking the now empty trailer to another Densification Compactor at another location where such waste is generated. FIG. 9 shows the Access Door Hinges (19) and the Pressure Washers (17) installed on the bottom of the Lower Trailer Door to assist in emptying and cleaning the trailer.

Insofar as the description above and the accompanying drawings disclose any additional subject matter that is not within the scope of the single claim below, the inventions are not dedicated to the public and the right to file one or more applications to claim such additional inventions is reserved. Although a very narrow claim is presented herein, it should be recognized the scope of this invention is much broader than presented by the claim. It is intended that broader claims will be submitted in an application that claims the benefit of priority from this application. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for food waste densification and removal comprising:
a tote to receive liquid and semi-liquid organic waste;
a scale to weigh the tote;
a two sided hopper;
a tractor means to lift the tote and pour it into the two sided hopper;
a control panel means;
a lid;
a lid enclosure operating means;
a liquid tight food waste compactor means comprised of a a food waste densification and liquid reduction tube assembly;
a trailer modified to be liquid tight by a liquid tight means;
the trailer attached to the output end of the liquid tight food waste compactor means;
a cleaning means to clean the food waste densification and liquid reduction tube assembly;
a cleaning means to clean the trailer; and
a sealable door means for the trailer.

2. A machine for food waste densification and removal as claimed in claim 1 wherein the trailer is air tight and impervious to vermin.

3. A machine for food waste densification and removal as claimed in claim 1 wherein latching dogs are used to attach the rear lower door to the trailer.

4. A machine for food waste densification and removal as claimed in claim 1 wherein a flat bar trash deflector is used to deflect the trash as it is pushed into the trailer.

5. A machine for food waste densification and removal as claimed in claim 1 wherein the compaction lid is hydraulically operated.

6. A machine for food waste densification and removal as claimed in claim 1 wherein the scale is an electronic scale means using a key card security access system.

7. A machine for food waste densification and removal as claimed in claim 1 wherein the cleaning means are pressure washers.

8. A machine for food waste densification and removal as claimed in claim 1 wherein the trailer sealing system is an outer rubber gasket and an inner rubber gasket anchored to a seam welded angle iron flange on the door.

9. A machine for food waste densification and removal as claimed in claim 1 wherein the liquid tight compactor means is comprised of a hydraulically operated piston operating a ram inside an outer cylinder.

10. A machine for food waste densification and removal as claimed in claim 1 wherein the tote dumper means is a a dumper rail lift assembly comprised of a chain operated pulley system.

11. A process for food waste densification and removal comprising the steps of:
filing a tote with liquid and semi-liquid organic waste;
using a scale to weigh the tote;
using a tractor means to lift the tote and pour it into a two sided hopper;
sealing the hopper with a lid operated by a lid enclosure operating means;
compacting the liquid and semi-liquid waste with a liquid tight food waste compactor means comprised of a a food waste densification and liquid reduction tube assembly;
pushing the compacted waste into a trailer modified to be liquid tight by a liquid tight means;
utilizing a cleaning means to clean the food waste densification and liquid reduction tube assembly;
disengaging the trailer from the liquid tight food waste compactor means,
transporting the trailer to a disposal site,
using a cleaning means to clean the trailer.

12. A process for food waste densification and removal as claimed in claim 11 wherein the cleaning means are pressure washers.

13. A process for food waste densification and removal as claimed in claim 11 wherein the liquid tight compactor means is comprised of a hydraulically operated piston operating a ram inside an outer cylinder.

14. A process for food waste densification and removal as claimed in claim 11 wherein the tote dumper means is a dumper rail lift assembly comprised of a chain operated pulley system.
